(19) United States
(12) Patent Application Publication
(10) Pub. No.: US 2023/0386073 A1
(43) Pub. Date: Nov. 30, 2023

(54) IMAGING STATUS MONITORING SYSTEM, IMAGING STATUS MONITORING METHOD, AND RECORDING MEDIUM

(71) Applicant: NEC Corporation, Minato-ku, Tokyo (JP)

(72) Inventor: Yuji TAHARA, Tokyo (JP)

(73) Assignee: NEC Corporation, Minato-ku, Tokyo (JP)

(21) Appl. No.: 18/032,063

(22) PCT Filed: Oct. 26, 2020
(86) PCT No.: PCT/JP2020/040119

§ 371 Date: Apr. 14, 2023

(51) Int. Cl. G06T 7/73; G06T 7/50

(52) U.S. Cl. CPC G06T 7/73; G06T 7/50

(57) ABSTRACT

An imaging status monitoring system includes: a reference image generation unit that generates a reference image information about a reference image including a reference part, based on a first image of an imaging target imaged in a predetermined period; an image acquisition unit that acquires a second image of the imaging target imaged; and an imaging status monitoring unit that determines an imaging status of whether or not the imaging target has been imaged, based on a relationship between a position of the reference part in the reference image and a position of a corresponding part in the second image, wherein the reference image generation unit sets the position of the reference part included in the reference image information to the position of the corresponding part, when the position of the reference part in the reference image is different from the position of the corresponding part.

### TECHNICAL FIELD

The present invention relates to an imaging status monitoring system, an imaging status monitoring method, and a recording medium that monitor an imaging status of a captured image.

### BACKGROUND ART

A known system of this type is configured to detect a change in angle of view of an imaging apparatus from an image taken by the imaging apparatus, on the basis of fixed point information including the position of a fixed point specified from the angle of view of the imaging apparatus and the feature quantity indicating a feature of the fixed point (e.g., see Patent Literature 1).

### CITATION LIST

### Patent Literature

Patent Literature 1: International Publication No. WO2014/010174

### SUMMARY

### Technical Problem

In the system disclosed in Patent Literature 1, however, when the change in the angle of view of the imaging apparatus is detected, the angle of view is only returned into a condition before the change, manually or automatically. Therefore, it is not configured to continue to monitor the imaging status in a condition after the change in the angle of view, which is technically problematic.

It is an example object of the present disclosure to provide an imaging status monitoring system, an imaging status monitoring method, and a recording medium that are configured to, even if an imaging status of an imaging target is changed, such as a change in the angle of view of an imaging apparatus, continue to monitor the imaging status in a condition after the change.

### Solution to Problem

An imaging status monitoring system according to an example aspect of the present disclosure includes: a reference image generation unit that generates reference image information about a reference image including a reference part, on the basis of a first captured image of an imaging target imaged in a predetermined period; an image acquisition unit that acquires a second captured image of the imaging target imaged after the predetermined period; and an imaging status monitoring unit that determines an imaging status of whether or not the imaging target has been imaged, on the basis of a relationship between a position of the reference part in the reference image and a position of a corresponding part corresponding to the reference part in the second captured image, wherein the reference image generation unit sets the position of the reference part included in the reference image information to the position of the corresponding part, when the position of the reference image is different from the position of the corresponding part.

An imaging status monitoring method according to an example aspect of the present disclosure includes: generating reference image information about a reference image including a reference part, on the basis of a first captured image of an imaging target imaged in a predetermined period; acquiring a second captured image of the imaging target imaged after the predetermined period; determining an imaging status of whether or not the imaging target has been imaged, on the basis of a relationship between a position of the reference part in the reference image and a position of a corresponding part corresponding to the reference part in the second captured image, and setting the position of the reference part included in the reference image information to the position of the corresponding part, when the position of the reference image is different from the position of the corresponding part.

A recording medium according to an example aspect of the present disclosure is a recording medium on which a computer program is recorded, wherein the computer program allows a computer to function as: a reference image generation unit that generates reference image information about a reference image including a reference part, on the basis of a first captured image of an imaging target imaged in a predetermined period; an image acquisition unit that acquires a second captured image of the imaging target imaged after the predetermined period; and an imaging status monitoring unit that determines an imaging status of whether or not the imaging target has been imaged, on the basis of a relationship between a position of the reference part in the reference image and a position of a corresponding part corresponding to the reference part in the second captured image, wherein the reference image generation unit sets the position of the reference part included in the reference image information to the position of the corresponding part, when the position of the reference image is different from the position of the corresponding part.

According to the imaging status monitoring system, the imaging status monitoring method, and the recording medium in the respective aspects described above, even if the imaging status of an imaging target is changed, it is possible to continue to monitor the imaging status in the condition after the change.

### BRIEF DESCRIPTION OF DRAWINGS

FIG. 1 is a diagram showing an example of an overall configuration of an imaging status monitoring system 1.

FIG. 2 is a diagram showing an example of a reference image.

FIG. 3 is a diagram showing an example of a comparison image.

FIG. 4 is a block diagram showing an example of a configuration of a server.

FIG. 5 is a flowchart showing a flow of process with respect to generation of the reference image.

FIG. 6 is a diagram showing that a reference part is detected from a plurality of first captured images.

FIG. 7 is a flowchart showing a flow of process with respect to monitoring of an imaging status.

### DESCRIPTION OF EXAMPLE EMBODIMENTS

### 1. Imaging Status Monitoring System

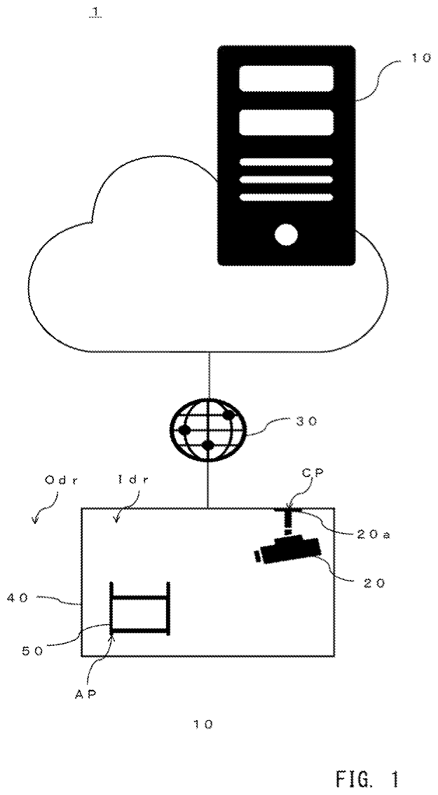

First, an overall configuration of an imaging status monitoring system 1 according to this example embodiment (hereinafter referred to as a “system 1”) will be described with reference to FIG. 1. FIG. 1 illustrates an example of the overall configuration of the system 1.

The system 1 monitors an imaging status of an imaging target 50 in a captured image, the imaging target 50 being imaged by a camera 20 that is an imaging apparatus. Then, the system 1 is configured, even if the imaging status is changed, to continue to monitor the imaging status of the imaging target 50 in a condition after the change. In order to realize such a system 1, the system 1 includes a server 10 that is configured to acquire the captured image taken by the camera 20. A connection aspect between the server 10 and the camera 20 is not limited. For example, the connection aspect may be of a network connection type through a communication network such as the Internet 30, or may be of a direct connection type. Furthermore, the connection aspect may be wired or wireless. The server 10 may be physically formed as a single server apparatus, or may be physically formed as a cloud server that is formed on a cloud by a plurality of server apparatuses.

The camera 20 may be installed at a predetermined position in one of an indoor area Idr or an outdoor area Odr of a building 40, for example. In the example in FIG. 1, the camera 20 is installed at a camera position CP that is a predetermined position in the indoor area Idr. The camera 20 faces the imaging target 50 so as to capture the imaging target 50. Although the camera position CP of the camera 20 in the example in FIG. 1 is shown as the position of a bonded part 20a of a member to the store 40, the member being for installing the camera 20, the camera position CP is not limited to this. The camera position CP may be any position that can be specified as a position in the store's indoor area Idr where the camera 20 is installed. The camera 20 may be configured to image the imaging target 50, periodically (e.g., once to several times per hour), for example. When the imaging target 50 is disposed at a predetermined position in the outdoor area Odr, the camera 20 may be installed at a camera position in the outdoor area Odr to image the imaging target 50 disposed in the outdoor area Odr. In this example embodiment, the building 40 may be a store 40 that sells food (including a shop and a sale corner for selling food, a food specialty store, a food floor of a supermarket, a department store and the like), as an example.

The imaging target 50 is an individual disposed at an arrangement position AP that is the predetermined position in the indoor area Idr. Alternatively, the imaging target 50 may be a part disposed at a predetermined position of a fixed object in the indoor area Idr. The imaging target 50 has a predetermined shape. For example, the imaging target 50 may be fixed to the arrangement position AP, or may be movable when some condition is satisfied (e.g., when some force is applied). In this example embodiment, the imaging target 50 may be a utensil 50 in which food is displayed in the store 40, as an example. In FIG. 1, the arrangement position AP of the utensil 50 is specified at, but not limited to, a position of an end 50a of one of legs of the utensil 50. The arrangement position AP may be any position that can be specified as a position in the store's indoor area Idr where the utensil 50 is disposed.

The server 10 monitors the imaging status of the imaging target 50 on the basis of the captured image in which the imaging target 50 is imaged (i.e., appears) by the camera 20. That is, in this example embodiment, the server 10 monitors the imaging status of the utensil 50 on the basis of the captured image where the utensil 50 is imaged by the camera 20, and determines whether or not the imaging status is changed. The imaging status includes, for example, the angle of view of the camera 20, the imaging environment (the weather, the illuminance, etc.) and the like. In this example embodiment, the “angle of view” refers to a relative positional relationship between the imaging target 50 and the camera 20. “Change in the angle of view” denotes a change in the relative positional relationship between the imaging target 50 and the camera 20. The “change in the angle of view” may include, for example, a change in the position of the utensil 50, a change in the direction of the camera 20, a change in the position of the camera 20, and the like.

### 2. Image to be Used to Monitor Imaging Status

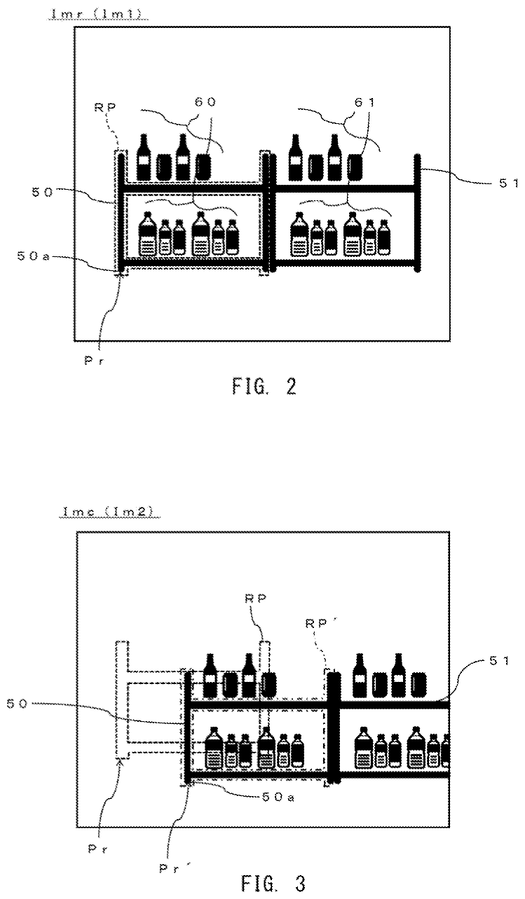

The server 10 determines whether or not there is a change in the imaging status by referring to and comparing a reference image and a comparison image. The reference image and the comparison image will be described with reference to FIG. 2 and FIG. 3.

### 2.1 Reference Image

FIG. 2 is an example of a reference image Imr that is referred to by the server 10. The reference image Imr is a captured image of the utensil 50 disposed at the arrangement position AP. The reference image Imr is referred to as a criterion when the server 10 determines whether or not there is a change in the imaging status. The reference image Imr may be generated on the basis of a plurality of first captured images Im1 of the utensil imaged over time by the camera 20 in a predetermined period, for example. A method of generating the reference image Imr will be described later.

In the example in FIG. 2, the reference image Imr shows a state that the utensil 50 that is the imaging target and another utensil 51 adjacent to the utensil 50 appear in the visual field range of the camera 20. As shown in FIG. 2, in the reference image Imr, a plurality of articles 60 may be displayed on each shelf of the utensil 50, and a plurality of articles 61 may be displayed on each shelf of the utensil 51. In the following description, an image part where each of the utensil 50, the utensil 51, the plurality of articles 60, and the plurality of articles 61 appears in the reference image Imr will be denoted by the same reference numeral as the corresponding one.

Hereinafter, in the reference image Imr, a part corresponding to the utensil 50 will be referred to as a “reference part RP” (a dotted line part). In the reference image Imr, a position of the reference part RP may be specified as a position of the end 50a of one of legs of the utensil 50 that appears. In the reference image Imr, the position of the reference part RP (hereinafter referred to as a “reference position Pr”) corresponds to the arrangement position AP of the utensil 50 in the store 40. The reference part RP includes a plurality of fixed points. The fixed point is a point at which the position is unchanged or may be regarded as unchanged between the plurality of first captured images. The plurality of fixed points may correspond to a plurality of feature points of the utensil 50 respectively. Each feature point of the utensil 50 is typically a position producing a feature of a shape of the utensil 50, and is, for example, each end, an apex of each corner, or the like of the utensil 50. The plurality of feature points of the utensil 50 may be set such that the utensil 50 is specified by the aggregate of the feature points, for example. Each feature point is specified, for example, by the position and the feature quantity (the image gradient, etc.). In the reference image Imr illustrated in FIG. 2, for example, the end 50a of one of legs of the utensil 50 appearing may be the fixed point.

The reference image Imr may be generated by the server 10, for example. Furthermore, the reference image Imr may be updated, as appropriate, by the server 10, for example. Reference image information that is information about the reference image Imr, may be maintained by the server 10, for example. The reference image information includes fixed point information (e.g., the position and the feature quantity) that allows each of the plurality of fixed points included in the reference part RP to be specified.

### 2.2 Comparison Image

FIG. 3 illustrates an example of a comparison image Imc that is referred to by the server 10. The comparison image Imc may be a second captured image Im2 taken by the camera 20 after the predetermined period for taking the first captured image Im1 (e.g., after the generation of the reference image information about the reference image Imr), for example. In the comparison image Imc, a reference part RP′ (an alternate long and short dash line part) corresponding to the reference part RP is located at a position Pr′. That is, in the example in FIG. 3, shown is a state that the reference part RP has been moved (i.e., changed) from the reference position Pr to the position Pr′. When attention is paid to the position of the end 50a that is the fixed point included in the reference part RP, in the comparison image Imc (FIG. 3), the end (the fixed point) 50a that originally stayed on the reference position Pr is on the reference position Pr′ different from the reference position Pr.

### 3. Configuration of Server

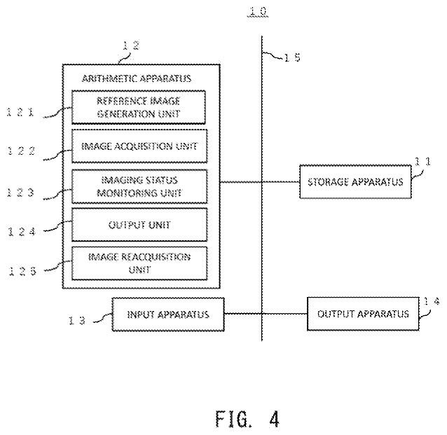

A configuration of the server 10 will be described with reference to FIG. 4. FIG. 4 is a block diagram showing an example of the configuration of the server 10. As shown in FIG. 4, the server 10 comprises a storage apparatus 11, an arithmetic apparatus 12, and an input apparatus 13. Furthermore, the server 10 may comprise an output apparatus 14. The storage apparatus 11, the arithmetic apparatus 12, the input apparatus 13, and the output apparatus 14 may be connected to each other through a data bus 15.

The storage apparatus 11 is configured to store desired data. For example, the storage apparatus 11 may temporarily store a computer program to be executed by the arithmetic apparatus 12. The storage apparatus 11 may temporarily store data being temporarily used by the arithmetic apparatus 12 when the arithmetic apparatus 12 is executing the computer program. The storage apparatus 11 may store data to be maintained for a long term by the server 10, such as, for example, the reference image information about the reference image Imr. The storage apparatus 11 may include at least one of a RAM (Random Access Memory), a ROM (Read Only Memory), a hard disk apparatus, a magneto-optical disk apparatus, and an SSD (Solid State Drive), and a disk array apparatus. That is, the storage apparatus 11 may include a volatile recording medium and a non-volatile recording medium.

The arithmetic apparatus 12 includes a CPU (Central Processing Unit), for example. The arithmetic apparatus 12 may be a computer unit including the CPU and a recording medium, such as, for example, a RAM and a ROM each recording various kinds of information necessary for operations of the CPU. The arithmetic apparatus 12 reads the computer program. For example, the arithmetic apparatus 12 may read the computer program stored in the storage apparatus 11. For example, the arithmetic apparatus 12 may read the computer program that is stored in a computer-readable non-volatile recording medium, using a not-shown recording medium reading apparatus. The arithmetic apparatus 12 may obtain (i.e., download or read) a computer program from a not-shown apparatus disposed outside the server 10 through the input apparatus 13. The arithmetic apparatus 12 executes the read computer program. Consequently, some logical functional blocks for executing operations to be performed by the server 10 are realized in the arithmetic apparatus 12. That is, the arithmetic apparatus 12 is capable of functioning as a controller for realizing the logical function blocks for executing the operations to be performed by the server 10.

FIG. 4 shows an example of the logical functional blocks realized in the arithmetic apparatus 12, for performing each process in the system 1. As shown in FIG. 4, in the arithmetic apparatus 12, a reference image generation unit 121, an image acquisition unit 122, an imaging status monitoring unit 123, an output unit 124, and an image reacquisition unit 125 are realized. The details of operations of each of the units 121 to 125 will be described later.

The input apparatus 13 is an apparatus that receives input of information to the server 10 from the outside of the server 10. The input apparatus 13 may accept the input (i.e., reception) of the information through some communication. For example, the input apparatus 13 may acquire (i.e., receive) various kinds of information, such as a captured image taken by the camera 20, directly or indirectly from the camera 20.

The output apparatus 14 is an apparatus that outputs information to the outside of the server 10. For example, the output apparatus 14 may output information relating to each process performed by the server 10, in an output state that can be recognized by a user. In addition, the output apparatus 14 may output (i.e., transmit) various kinds of information to the other server or system. The output state that can be recognized by the user includes, for example, a display output by a screen or the like that is the output apparatus 14, an audio output by a speaker or the like that is the output apparatus 14, and a print output by a printer or the like that is the output apparatus 14.

### 4. Operation of Each Functional Block Formed in Server

The operation of each of the functional blocks 121 to 125 formed in the arithmetic apparatus 12 of the server 10 will be described.

The reference image generation unit 121 detects the reference part RP and generates the reference image information about the reference image Imr, for example, on the basis of the plurality of first captured images Im1 of the utensil 50 taken in the predetermined period, the utensil 50 being disposed at the arrangement position AP in the store's indoor area Idr. In addition, for example, when the angle of view of the camera is changed (e.g., when the utensil 50 is moved), the reference image generation unit 121 may generate a new reference image Imr on the basis of a condition of the utensil 50 after the change.

The image acquisition unit 122 acquires the comparison image Imc (i.e., the second captured image Im2) of the utensil 50 imaged by the camera 20, through the input apparatus 13, after the predetermined period for taking the first captured image Im1 (e.g., after the generation of the reference image information), for example. The image acquisition unit 122 may acquire the comparison image Imc, periodically at each predetermined time (e.g., once every 30 minutes or once per hour). Additionally, the image acquisition unit 122 may acquire a plurality of first captured images Im1 for generating the reference image Imr, through the input apparatus 13.

The imaging status monitoring unit 123 monitors the imaging status of the utensil in the captured image on the basis of the reference image Imr and the comparison image Imc (the second captured image Im2). The imaging status monitoring unit 123 determines the imaging status of whether or not the utensil 50 has been imaged, on the basis of a relationship between the reference position Pr of the reference part RP in the reference image Imr and the position Pr′ of the reference part RP′ in the comparison image Imc (the second captured image Im2), for example. The imaging status monitoring unit 123 may determine that the utensil 50 has not been imaged, for example, when the reference part RP′ is not detected in the vicinity of the reference position Pr in the comparison image Imc (e.g., when a difference between the reference position Pr and the position Pr′ exceeds a predetermined first threshold), for example.

The output unit 124 outputs information about the imaging status of the comparison image Imc from the output apparatus 14 in accordance with the difference between the reference position Pr of the reference part RP and the position Pr′ of the reference part RP′, for example. For example, when a plurality of levels are set for the difference, the output unit 124 may output a notice corresponding to each level (e.g., a warning or a recommendation for confirmation), from the output apparatus 14. Alternatively, for example, when a predetermined second threshold (>the first threshold) is set with respect to the difference and when the difference exceeds the second threshold, the output unit 124 may output a predetermined notice (e.g., a warning or a recommendation for confirmation) from the output apparatus 14. The “notice” includes, for example, a warning of occurrence of abnormality in the captured image, a recommendation for confirming the state of the camera 20, and a recommendation for confirming the state of the utensil 50, and the like.

The image reacquisition unit 125 allows the camera 20 to re-image the utensil and allows the image acquisition unit 122 to reacquire the re-imaged first captured image Im1 or the re-imaged second captured image Im2, when the utensil 50 has not been imaged, with respect to the first captured image Im1 or the second captured image Im2. When the camera 20 has a function of storing captured images, the image acquisition unit 122 may be allowed to reacquire the first captured image Im1 or the second captured image Im2 stored by the camera 20.

### 5. Process by Server

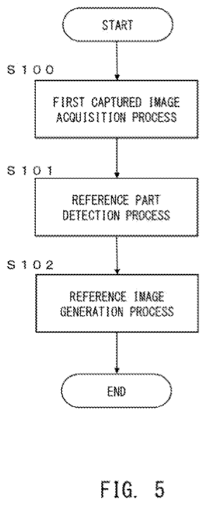

The server 10 generates the reference image Imr and monitors the imaging status of the utensil 50 on the basis of the reference image Imr and the comparison image Imc. Then, for example, when the angle of view of the camera 20 is changed, the server 10 updates the reference image Imr. A flow of the process performed by the server 10 will be described with reference to FIG. 5 to FIG. 7. First, an example of the flow of the process with respect to the generation of the reference image Imr will be described with referring to FIG. 5. A processing routine shown in FIG. 5 is executed by the reference image generation unit 121 of the server 10.

The server 10 firstly performs a first captured image acquisition process (step S100). In the first captured image acquisition process, the server 10 allows, for example, the image acquisition unit 122 to acquire a plurality of first captured images Im1 taken in a predetermined time. The “predetermined time” is, for example, a duration time set in advance as a duration time to take the plurality of first captured images Im1 for generating the reference image Imr. The “predetermined time” may be about several seconds, for example. The number of the first captured images Im1 to be taken may be any number of the images that can be taken in the predetermined time.

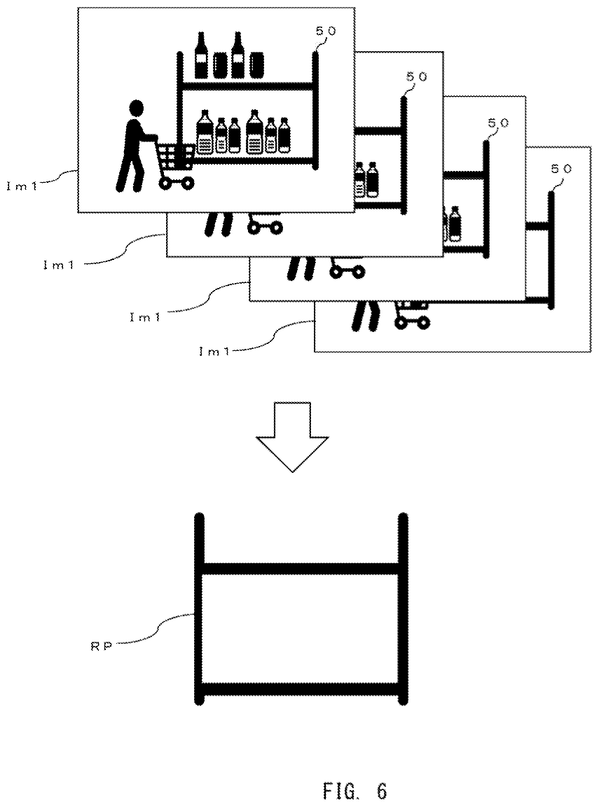

Subsequently, the server 10 performs a reference part detection process (step S101). In the reference part detection process, the server 10 firstly extracts a plurality of feature points from each of the plurality of first captured images Im1. The feature point is specified, for example, by the position and the feature quantity, as described above. Thus, the server 10 may, for example, generate feature point information including the position and the feature quantity and store it in the storage apparatus 11, with respect to each feature point. As illustrated in FIG. 6, the server 10 specifies, as the fixed point, the feature point whose position is unchanged or may be regarded as unchanged between the plurality of first captured images Im1. The fixed point is also specified, for example, by the position and the feature quantity similarly to the feature point. Therefore, the server 10 may, for example, generate fixed point information including the position and the feature quantity and store it in the storage apparatus 11, with respect to each of specified fixed points. For example, the server 10 may store in the storage apparatus 11, the feature point information about the corresponding feature point as the fixed point information. The aggregate of the specified fixed points corresponds to the reference part RP. Thereby, the reference part RP is detected.

The server 10 may, when extracting the feature point, use shape information about a shape (i.e., a two-dimensional shape) in which the utensil 50 appears in the captured image of the camera 20. In this case, the server 10 may extract an image part in which the utensil 50 appears from each first captured image Im1 by using the shape information, and may focus on the extracted image part to extract the feature points. Thereby, even in the first captured image Im1 where a state that the articles 60 remain placed on the utensil 50 has been captured, it is possible to avoid that any feature point of the articles 60 is extracted. The shape information about the utensil 50 may be stored in the storage apparatus 11 for a long time, for example. Alternatively, the shape information about the utensil 50 may be inputted through the input apparatus 13 each time the shape information is used, and may be temporarily stored in the storage apparatus 11.

Back to FIG. 5, the server 10 performs the reference part detection process (the step S101) and then performs a reference image generation process (the step S102). In the reference image generation process, the reference image Imr including the reference part RP that is the aggregate of the specified fixed points is generated. The server 10, for example, generates the reference image information about the generated reference image Imr and stores it in the storage apparatus 11. The reference image information includes the fixed point information about a plurality of fixed points included in the reference part RP. The server 10 may refer to the reference image information in the process relating to the reference image Imr, as appropriate, for example.

The server 10 may generate the reference image Imr corresponding to the imaging environment. The server 10 may generate the reference image Imr according to an illuminance level (i.e., a brightness level) in the store's indoor area Idr, for example. In this case, the server 10 may, for example, specify the illuminance level in the store's indoor area Idr when the reference image Imr is generated, and set the generated reference image Imr as the reference image Imr for the specified illuminance level. For example, the server 10 may obtain weather information at the time of imaging from a predetermined weather information providing site, and specify the illuminance level at the time of imaging from the obtained weather information. Additionally/Alternately, for example, the server 10 may specify the illuminance level at the time of imaging from an imaging date and time.

The server 10 may, for example, generate the reference image Imr by using the above generation method for each different illuminance level. Alternatively, the server 10 may obtain, on the basis of the illuminance level corresponding to the generated reference image Imr, the reference image Imr for the other illuminance level by using a predetermined equation, a predetermined arithmetic model, or the like. Each illuminance level may be set as appropriate, in accordance with the imaging environment of an actual imaging site. The server 10 may associate imaging environmental information about the imaging environment (e.g., the illuminance level) with the reference image Imr and may store it in the storage apparatus 11, for example.

The server 10 may detect the reference part RP to generate the reference image Imr by extracting a plurality of feature points from one first captured image Im1 as the plurality of fixed points with respect to the utensil 50. Furthermore, in the step S101, for example, when the reference part RP cannot be detected due to a failure in at least one first captured image Im1, the server 10 may reacquire at least one first imaging Im1 by using the image reacquisition unit 125.

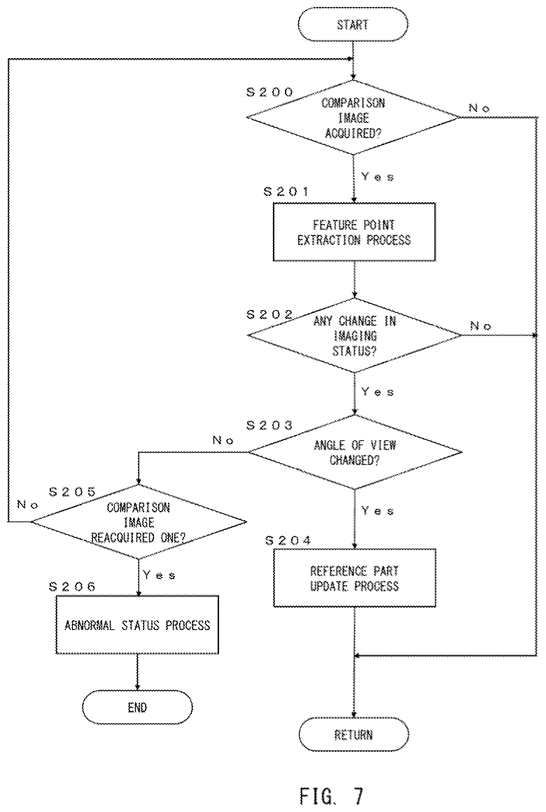

An example of a flow of a process about monitoring of the imaging status of the utensil 50 performed by the server 10 will be described with reference to FIG. 7. A processing routine shown in FIG. 7 is performed, for example, after the generation of the reference image information about the first reference image Imr. The processing routine shown in FIG. 7 is performed by the arithmetic apparatus 12 of the server 10.

The server 10 firstly determines whether or not the image acquisition unit 122 acquires the comparison image Imc from the camera 20 (step S200). The server 10 repeats the step S200 until the comparison image Imc is acquired from the camera 20. When the image acquisition unit 122 acquires the comparison image Imc (step S200: Yes), the server 10 performs a feature point extraction process (step S201). In the feature point extraction process, the server 10 extracts a plurality of feature points from the comparison image Imc acquired, and obtains the feature point information (the position and the feature quantity) about each feature point. The server 10 may use the shape information described above, when extracting the feature point.

Subsequently, the server 10 determines whether or not there is a change in the imaging status (step S202). In the step S201, for example, when the feature point can be extracted at the position of each fixed point (or the position that may be regarded as the position of each fixed point) included in the reference part RP in the comparison image Imc, the server 10 may determine that there is no change in the imaging status. For example, the server 10 may determine that the feature point can be extracted at the position of the fixed point (or the position that may be regarded as the position of the fixed point) when the difference between the position Pr of the fixed point in the reference part RP and the position Pr′ of the feature point corresponding to the fixed point in the comparison image Imc is within the first threshold. Furthermore, the server 10 may determine that the feature point cannot be extracted at the position of the fixed point (or the position that may be regarded as the position of the fixed point) when the difference between the position Pr of the fixed point and the position Pr′ of the feature point exceeds the first threshold. That is, the server 10 may determine that the feature point can be extracted at the position of the fixed point (or the position that may be regarded as the position of the fixed point) when the difference between the reference position Pr of the reference part RP and the position Pr′ of the reference part RP′ corresponding to the reference part RP in the comparison image Imc is within the first threshold. Furthermore, the server 10 may determine that the feature point cannot be extracted at the position of the fixed point (or the position that may be regarded as the position of the fixed point) when the difference between the reference position Pr of the reference part RP and the position Pr′ of the reference part RP′ exceeds the first threshold. For example, when a plurality of feature points are extracted in the vicinity of the position Pr of the fixed point, the server 10 may specify the feature point that is the closest to the position Pr of the fixed point, as the feature point corresponding to the fixed point.

When it is determined that there is no change in the imaging status (step S202: No), the server 10 returns the processing routine to the step S200. On the other hand, in the step S201, for example, when the feature point cannot be extracted at the position of any one of the fixed points (or the position that may be regarded as the position of any one of the fixed points) in the comparison image Imc, the server 10 determines that there is a change in the imaging status. When it is determined that there is a change in the imaging status (step S202: Yes), the server 10 determines whether or not the angle of view of the camera 20 has been changed (step S203).

The server 10 may determine that the view angle of the camera 20 has been changed (e.g., by the position of the utensil 50 is moved) when the difference between the position Pr of the fixed point included in the reference part RP and the position Pr′ of the feature point corresponding to the fixed point in the comparison image Imc is within the second threshold, for example. That is, the server 10 may determine that the angle of view of the camera 20 has been changed when the difference between the reference position Pr of the reference part RP and the position Pr′ of the reference part RP′ corresponding to the reference part RP in the comparison image Imc is within the second threshold, for example. When it is determined that the angle of view of the camera 20 has been changed (step S203: Yes), the server 10 progresses the processing routine to step S204 for a process to be executed when the angle of view of the camera 20 has been changed. On the other hand, the server 10 may determine that there is an abnormality in the imaging status when the difference between the reference position Pr of the reference part RP and the position Pr′ of the reference part RP′ exceeds the second threshold, or when the feature point corresponding to the fixed point cannot be extracted from the comparison image Imc, for example. The server 10 progresses the processing routine to step S205 when it is determined that there is an abnormality in the imaging status (step S203: No).

The threshold (at least one of the first threshold and the second threshold) of the difference used in each of the step S202 and the step S203 may be provided in accordance with the imaging environment. For example, the threshold of the difference may be provided in accordance with the illuminance level in the store's indoor area Idr. For example, by using the threshold of the difference matching the illuminance level of the store's indoor area, the server 10 is allowed to determine the imaging status in view of a difference in illuminance in the store's indoor area Idr, the difference being caused by the weather and the date and time. For example, the server 10 may obtain the weather information at the time of imaging from a predetermined weather information providing site, and may specify the illuminance level at the time of imaging from the weather information obtained. Additionally/Alternately, for example, the server 10 may specify the illuminance level at the time of imaging from the imaging date and time.

In the step S204, the server 10 performs a reference part update process. The reference part update process is performed when it is determined that the angle of view of the camera 20 has been changed, as described above. In the reference part update process, the server 10 generates a new reference image Imr on the basis of a condition in which the reference part RP has been moved (i.e., the comparison image Imc), and updates the reference image information on the basis of the new reference image Imr. The server 10 may set the comparison image Imc as the new reference image Imr, for example. Therefore, the server 10 may set the reference part RP′ in the comparison image Imc as a new reference part RP in the new reference image Imr. That is, the server may set the feature point that is on the position Pr′ in the comparison image Imc, as a new fixed point that is on the new reference position Pr in the new reference image Imr, for example. A plurality of feature points of the reference part RP′ in the comparison image Imc are set as a plurality of fixed points in the new reference image Imr, by which the new reference part RP in the new reference image Imr is specified. The server 10 updates the reference image information by using a plurality of new fixed points included in the new reference part RP such that the reference image information becomes information with respect to the new reference image Imr. The server 10 returns the processing routine to step S200 to continue the monitoring process on the basis of the reference image information updated.

The server 10 may generate the new reference image Imr by using the processing routine shown in FIG. 5. That is, the server 10 may generate the new reference image Imr on the basis of the plurality of first captured images Im1 taken over time in the predetermined period. The new reference image Imr may also be generated in accordance with the imaging environment. For example, the server 10 may generate the new reference image Imr in accordance with the illuminance level in the store's indoor area Idr, as described above.

In the step 205, the server 10 determines whether or not the comparison image Imc is a reacquired one. When the comparison image Imc is not the reacquired one (step S205: No), the server 10 returns the processing routine to step S200 to reacquire the comparison image Imc. When the comparison image Imc is the reacquired one (step S205: Yes), the server 10 performs an abnormal status process (step S206). The server may acquire the comparison image Imc twice or more. In such a case, the server 10 may manage the number of times that the comparison image Imc is reacquired.

In the abnormal status process in the step S206, the server 10 may determine the imaging status in which the comparison image Imc has been taken, and may output a notice to the user corresponding to the determined imaging status, through the output apparatus 14, for example. The notice to the user includes, for example, a warning, a recommendation for confirmation, or the like. For example, when the difference between the reference position Pr and the position Pr′ of the reference part RP′ in the comparison image Imc exceeds the second threshold, the server 20 may determine that the angle of view of the camera 20 has been changed beyond an assumed range, and may recommend the user to confirm the site. For example, when the reference part RP′ is not detected from the comparison image Imc, the server 10 may determine that some abnormality has occurred, and may recommend the user to confirm the site. For example, when the server 10 determines that the comparison image Imc shows a state that could be determined to be bad weather (e.g., a state that could be determined to be affected by snow or raindrops), the server 10 may notify the user that the comparison image Imc cannot be acquired due to the bad weather. Thus, it is possible to prevent that the abnormality in the comparison image Imc caused by the bad weather is considered to be the abnormality caused by the imaging status. For example, the server 10 may have information about images each showing a status that could be determined to be the bad weather, in the storage apparatus 11. The server 10 ends the processing routine in FIG. 7 after the step S206.

In the abnormal status process, when the comparison image Imc shows the state that could be determined to be the bad weather, the server 10 may not notify the user. In this case, for example, when the weather has recovered the state so that the comparison image Imc can be acquired, the server 10 may restart the processing routine in FIG. 7. Alternatively, the server 10 may restart the processing routine in FIG. 7 after a lapse of a predetermined time from the end of the processing routine in FIG. 7, for example. To restart the processing routine in FIG. 7, the server 10 may receive input through the input apparatus 13 by the user, for example. Alternatively, to restart the processing routine in FIG. 7, the server 10 may obtain the information about the weather in the vicinity of the store 40 from a weather information providing site providing the weather information.

In the processing routine shown in FIG. 7, the server 10 may specify and use the reference image Imr suiting the imaging environment, as appropriate. For example, the server 10 may specify the illuminance level at the time of imaging from the date and time of the imaging (or from an illuminance sensor provided in the store 40) and may use the reference image Imr corresponding to the illuminance level specified. For example, the server 10 may obtain the weather information at the time of imaging from a predetermined weather information providing site, specify the illuminance level at the time of imaging from the weather information obtained, and use the reference image Imr corresponding to the illuminance level specified. Alternatively, the server 10 may specify the illuminance level at the time of imaging from the imaging date and time.

In the processing routine shown in FIG. 7, the step S200 is performed by the image acquisition unit 122 of the server 10. The step S201 to the step S203 are performed by the imaging status monitoring unit 123 of the server 10. The step S204 is performed by the reference image generation unit 121 of the server 10. The step S205 is performed by the image reacquisition unit 125 of the server 10. The step S206 is performed by the output unit 124 of the server 10.

### <Supplementary Note>

The following Supplementary Notes are further disclosed with respect to the example embodiments described above.

### (Supplementary Note 1)

An imaging status monitoring system described in Supplementary Note 1 is an imaging status monitoring system comprising: a reference image generation unit that generates reference image information about a reference image including a reference part, on the basis of a first captured image of an imaging target imaged in a predetermined period; an image acquisition unit that acquires a second captured image of the imaging target imaged after the predetermined period; and an imaging status monitoring unit that determines an imaging status of whether or not the imaging target has been imaged, on the basis of a relationship between a position of the reference part in the reference image and a position of a corresponding part corresponding to the reference part in the second captured image, wherein the reference image generation unit sets the position of the reference part included in the reference image information to the position of the corresponding part, when the position of the reference image is different from the position of the corresponding part.

According to the imaging status monitoring system described in Supplementary Note 1, when it is determined that the position of the reference part that is a criterion of the position of the imaging target is changed under the monitoring of the imaging status of the imaging target, the position of the reference part of the reference image information is updated to its corresponding position after the change. Thus, even if the position of the imaging target is changed, it is possible to continue to monitor the imaging status by using the reference image automatically updated.

### (Supplementary Note 2)

An imaging status monitoring system described in Supplementary Note 2 is the imaging status monitoring system described in the supplementary note 1, wherein the reference image information includes information about an imaging environment, the imaging status monitoring unit determines the imaging status on the basis of a predetermined threshold and a difference between the position of the reference part and the position of the corresponding part, the predetermined threshold being set on the basis of the imaging environment.

According to the imaging status monitoring system described in Supplementary Note 2, it is possible to determine the imaging status on the basis of the difference between the position of the reference part and the position of the corresponding part, by using the threshold corresponding to the imaging environment. It is thus possible to consider an illumination level at which the second image is obtained, to be the imaging environment, for example, thereby making a more accurate determination.

### (Supplementary Note 3)

An imaging status monitoring system described in Supplementary Note 3 is the imaging status monitoring system described in Supplementary Note 1 or 2, further including an output unit that performs processing relating to an output so that an output with respect to the imaging status is performed to a user on the basis of a difference between the position of the reference part and the position of the corresponding part.

According to the imaging status monitoring system described in Supplementary Note 3, for example, when the difference between the position of the reference part and the position of the corresponding part has a size that exceeds an assumed range, a notice of warning or recommendation for conformation may be given to a user. Alternatively, a necessary notice may be given to the user in accordance with a level of the magnitude of the difference.

### (Supplementary Note 4)

An imaging status monitoring system described in Supplementary Note 4 is the imaging status monitoring system described in any one of Supplementary Notes 1 to 3, including a shape information about a shape of the imaging target, wherein the reference image generation unit sets a part corresponding to the shape information as the reference part, in the first captured image.

According to the imaging status monitoring system described in Supplementary Note 4, when extracting the feature point in the first captured image, the reference image generation unit is allowed to use the shape information as a template. Thereby, the reference image generation unit is allowed to extract an image part in which the imaging target appears from the first captured image by using the shape information and to focus on the extracted image part to extract the feature point. Therefore, it is possible to avoid the extraction of the feature point in an image part in which the other object that is not the imaging target appears. For example, when there is the other object than the imaging target, a captured image where the imaging target has been imaged in a state that the other object remains present, may be used as the first captured image.

### (Supplementary Note 5)

An imaging status monitoring system described in Supplementary Note 5 is the imaging status monitoring system described in any one of Supplementary Notes 1 to 4, further comprising an image reacquisition unit that allows an imaging apparatus to reimage the imaging target and reacquires the second captured image, when the corresponding part is not extracted from the second captured image.

According to the imaging status monitoring system described in Supplementary Note 5, for example, when the feature point is not extracted due to temporary factors (e.g., when the moment that an object or a person passes through between the imaging target and the camera has been captured), the second captured image is reacquired. Thus, it is possible to prevent that the imaging status monitoring unit determines that the imaging status has been changed due to the temporary factors.

The reference image generation unit may generate the reference image in accordance with the imaging environment. Accordingly, the reference image generation unit may (i) generate a first reference image information, on the basis of a plurality of the first captured images generated by imaging the imaging target by using the imaging apparatus that is in a first imaging environment, and (ii) generate a second reference image information that is different from the first reference image information, on the basis of a plurality of the first captured images generated by imaging the imaging target by using the imaging apparatus that is in a second imaging environment that is different from the first imaging environment.

### (Supplementary Note 6)

An imaging status monitoring system described in Supplementary Note 6 is the imaging status monitoring system described in any one of Supplementary Notes 1 to 5, wherein the reference image generation unit generates, on the basis of a plurality of the first captured images of the imaging target imaged in the predetermined period, the reference image information about the reference image with setting a part with no change of the plurality of the first captured images as the reference part.

According to the imaging status monitoring system described in Supplementary Note 6, the reference image generation unit generates the reference image by using the plurality of first captured images. For example, even when the first captured image that is not in a normal condition is acquired due to temporary factors (e.g., a case that the moment that an object or a person passes through between the imaging target and the camera has been captured), the reference image generation unit is allowed to generate the reference image where a part with no change is set as the reference part, on the basis of the other first captured images that are in a normal condition.

### (Supplementary Note 7)

An imaging status monitoring system described in Supplementary Note 7 is the imaging status monitoring system described in any one of Supplementary Notes 1 to 6, wherein, the reference part includes at least one feature point of the imaging target as a fixed point, the reference image information includes fixed point information about the fixed point included in the reference part, the imaging status monitoring unit determines the imaging status on the basis of a relationship between a position of the fixed point in the reference image and the position of the corresponding part, and the reference image generation unit sets the position of the reference part included in the reference image information to the position of the corresponding part in the second captured image, when the position of the fixed point in the reference image is different from the position of the corresponding part.

According to the imaging status monitoring system described in Supplementary Note 7, the reference part of the reference image can be treated as an aggregate of a plurality of fixed points. Therefore, for example, it is possible to specify the position of the reference part as the position of the fixed point.

### (Supplementary Note 8)

An imaging status monitoring method described in Supplementary Note 8 is an imaging status monitoring method including: generating reference image information about a reference image including a reference part, on the basis of a first captured image of an imaging target imaged in a predetermined period; acquiring a second captured image of the imaging target imaged after the predetermined period; determining an imaging status of whether or not the imaging target has been imaged, on the basis of a relationship between a position of the reference part in the reference image and a position of a corresponding part corresponding to the reference part in the second captured image, and setting the position of the reference part included in the reference image information to the position of the corresponding part, when the position of the reference image is different from the position of the corresponding part.

According to the imaging status monitoring method described in Supplementary Note 8, similarly to the imaging status monitoring system described in Supplementary Note 1, when it is determined that the position of the reference part that is a criterion of the position of the imaging target has been changed under the monitoring of the imaging status of the imaging target, the position of the reference part of the reference image information is updated to its corresponding position after the change. Thus, even if the position of the imaging target is changed, it is possible to continue to monitor the imaging status by using the reference image automatically updated.

### (Supplementary Note 9)

A recording medium described in Supplementary Note 9 is a recording medium on which a computer program is recorded, wherein the computer program allows a computer to function as:

a reference image generation unit that generates reference image information about a reference image including a reference part, on the basis of a first captured image of an imaging target imaged in a predetermined period; an image acquisition unit that acquires a second captured image of the imaging target imaged after the predetermined period; and an imaging status monitoring unit that determines an imaging status of whether or not the imaging target has been imaged, on the basis of a relationship between a position of the reference part in the reference image and a position of a corresponding part corresponding to the reference part in the second captured image, wherein the reference image generation unit sets the position of the reference part included in the reference image information to the position of the corresponding part, when the position of the reference image is different from the position of the corresponding part.

According to the computer program stored in the recording medium described in Supplementary Note 9, the imaging status monitoring system described in Supplementary Note 1 can be realized.

This disclosure is not limited to the above-described examples and is allowed to be changed, if desired, without departing from the essence or spirit of the invention which can be read from the claims and the entire specification. An imaging status monitoring system, an imaging status monitoring method, and a recording medium with such modifications are also intended to be within the technical scope of this disclosure.

### DESCRIPTION OF REFERENCE CODES

1 Imaging status monitoring system
10 Server
20 Camera (Imaging apparatus)
50 Utensil (Imaging target)
RP, RP′ Reference part
Imr Reference image
Im1 First captured image
Im2 Second captured image
121 Reference image generation unit
122 Image acquisition unit
123 Imaging status monitoring unit
124 Output unit
125 Image reacquisition unit

What is claimed is:

1. An imaging status monitoring system comprising:
at least one memory configured to store instructions; and
at least one processor configured to execute the instructions to:
generate reference image information about a reference image including a reference part, on the basis of a first captured image of an imaging target imaged in a predetermined period;
acquire a second captured image of the imaging target imaged after the predetermined period;
determine an imaging status of whether or not the imaging target has been imaged, on the basis of a relationship between a position of the reference part in the reference image and a position of a corresponding part corresponding to the reference part in the second captured image, and
set the position of the reference part included in the reference image information to the position of the corresponding part, when the position of the reference image is different from the position of the corresponding part.

2. The imaging status monitoring system according to claim 1, wherein
the reference image information includes information about an imaging environment;
the at least one processor is configured to execute the instructions to determine the imaging status on the basis of a predetermined threshold and a difference between the position of the reference part and the position of the corresponding part, the predetermined threshold being set on the basis of the imaging environment.

3. The imaging status monitoring system according to claim 1, the at least one processor is configured to execute the instructions to perform processing relating to an output so that an output with respect to the imaging status is performed to a user on the basis of a difference between the position of the reference part and the position of the corresponding part.

4. The imaging status monitoring system according to claim 1, including a shape information about a shape of the imaging target, wherein
the at least one processor is configured to execute the instructions to
set a part corresponding to the shape information as the reference part, in the first captured image.

5. The imaging status monitoring system according to claim 1, wherein the at least one processor is further configured to execute the instructions to allow an imaging apparatus to reimage the imaging target and reacquires the second captured image, when the corresponding part is not extracted from the second captured image.

6. The imaging status monitoring system according to claim 1, the at least one processor is configured to execute the instructions to generate, on the basis of a plurality of the first captured images of the imaging target imaged in the predetermined period, the reference image information about the reference image with setting a part with no change of the plurality of the first captured images as the reference part.

7. The imaging status monitoring system according to claim 1, wherein,
the reference part includes at least one feature point of the imaging target as a fixed point,
the reference image information includes fixed point information about the fixed point included in the reference part, and
the at least one processor is configured to execute the instructions to:
determine the imaging status on the basis of a relationship between a position of the fixed point in the reference image and the position of the corresponding part, and
set the position of the reference part included in the reference image information to the position of the corresponding part in the second captured image, when the position of the fixed point in the reference image is different from the position of the corresponding part.

8. An imaging status monitoring method comprising:
generating reference image information about a reference image including a reference part, on the basis of a first captured image of an imaging target imaged in a predetermined period;
acquiring a second captured image of the imaging target imaged after the predetermined period;
determining an imaging status of whether or not the imaging target has been imaged, on the basis of a relationship between a position of the reference part in the reference image and a position of a corresponding part corresponding to the reference part in the second captured image, and
setting the position of the reference part included in the reference image information to the position of the corresponding part, when the position of the reference image is different from the position of the corresponding part.

9. A non-transitory recording medium on which a computer program that allows a computer execute an imaging status monitoring method is recorded, the imaging status monitoring method comprising:
generating reference image information about a reference image including a reference part, on the basis of a first captured image of an imaging target imaged in a predetermined period;
acquiring a second captured image of the imaging target imaged after the predetermined period;
determining an imaging status of whether or not the imaging target has been imaged, on the basis of a relationship between a position of the reference part in the reference image and a position of a corresponding part corresponding to the reference part in the second captured image; and
setting the position of the reference part included in the reference image information to the position of the corresponding part, when the position of the reference image is different from the position of the corresponding part.
